(19) United States
(12) Patent Application Publication
(10) Pub. No.: US 2018/0276612 A1
(43) Pub. Date: Sep. 27, 2018

(54) Vehicle Tracking Device

(71) Applicant: CARE4ALL APS, Esbjerg N (DK)

(72) Inventor: Jan NØRSKOV LAURSEN, Esbjerg (DK)

(21) Appl. No.: 15/953,859

(22) Filed: Apr. 16, 2018

Related U.S. Application Data
(63) Continuation of application No. PCT/DK2016/050343, filed on Oct. 28, 2016.

(30) Foreign Application Priority Data
Oct. 30, 2015 (DK) PA 2015 00671

(51) Int. Cl. G06Q 10/08; B60Q 1/30; B60R 16/03

(52) U.S. Cl. CPC G06Q 10/0833; B62D 63/08; B60R 16/03; B60Q 1/305

(57) ABSTRACT

A tracking device for a vehicle is disclosed. The tracking device comprises a light device for providing light (driving light, stop light indicator). The tracking device comprises:
an energy storage;
a positioning unit configured to determine the position of the tracking device and
a communication module configured to transmit wireless signals to an external receiver.

The tracking device comprises an energy harvesting device configured to charge the energy storage by the electrical power available in the electrical wires connected to the light device of the vehicle.

### FIELD OF INVENTION

The present invention relates to a vehicle tracking device for determining and transmitting the position of a vehicle to an end user. The present invention more particularly relates to a vehicle tracking device that does not need a battery.

### PRIOR ART

In order to keep track of the positon of vehicles such as trailers and the goods that they transport, it is important to be able to track the position of the trailer.

In several areas in the world, truck trailers are not required to use driving light. Accordingly, electrical devices electrically connected to the light device of such trailers can typically not be supplied with sufficient electrical power. Accordingly, the prior art tracking devices require a rather large battery in order to secure that sufficient electrical power is available for the tracking device. Therefore, the prior art tracking devices are large and expensive. Moreover, batteries lose a percentage of their original charge when stored. Batteries that are stored for a long period or that are discharged at a small fraction of the capacity lose capacity due to the presence of generally irreversible energy consuming side reactions without producing current. This loss is known as the internal self-discharge rate. Since batteries discharges, batteries in in tracking devices are required to have a large capacity in order to ensure that the tracking device is sufficiently energised over time. Moreover, rechargeable batteries are not indefinitely rechargeable due to dissipation of the active materials, internal corrosion and loss of electrolyte. After a plurality of recharges, basically all capacity is lost and the battery stops producing power and the internal resistance permanently increases beyond usable values.

E.g. from JP 2006015912 A, a tracking device is known. The tracking device is for a vehicle comprising a light device for providing light, wherein the tracking device comprises an energy storage, a positioning unit configured to determine the position of the tracking device, and a communication module configured to transmit wireless signals to an external receiver, wherein the tracking device comprises an energy harvesting device configured to charge the energy storage by the electrical power available in the electrical wires connected to the indicator lights of the vehicle. The energy harvesting device comprises more capacitors. However, the known tracking device may discharge over time.

Accordingly, it would be desirable to provide a tracking device that reduces or even eliminates the above mentioned disadvantages of the prior art.

It is an object of the present invention to provide a tracking device that does not require a battery for securing that sufficient electrical power is available for the tracking device.

### SUMMARY OF THE INVENTION

The object of the present invention can be achieved by a tracking device having the features as defined herein. Preferred embodiments are defined in the dependent sub claims, explained in the following description and illustrated in the accompanying drawings.

The tracking device according to the invention is a tracking device for a vehicle comprising a light device for providing light, wherein the tracking device comprises:
an energy storage;
a positioning unit configured to determine the position of the tracking device and
a communication module configured to transmit wireless signals to an external receiver,
   wherein the tracking device comprises an energy harvesting device (a power charging device) configured to charge the energy storage by the electrical power available in the electrical wires connected to the light device of the vehicle, said light device being selected among the indicator lights, the reversing lights, the braking lights, the turn signals, and combinations thereof, and wherein the energy harvesting device is a charge pump.

The terms “energy harvesting device” and “power charging device” is used interchangeably herein. The device is such suitable for the purpose of the invention. The device is capable of collecting and/or storing energy.

The term “a light device” as used within this context and throughout this application is intended to encompass one or more of the lights mentioned above. Thus, the term “a light device” also encompass “light devices”.

Hereby, it is possible to provide a tracking device that does not require a battery for securing that sufficient electrical power is available for the tracking device.

The tracking device according to the invention is a tracking device for a vehicle comprising a light device for providing light. The light device may be a driving light, stop light, turn signal, indicator lights, reversing lights, braking lights as well as combinations thereof. By combinations thereof is meant that the light device may comprise more than one of the driving lights, stop lights, indicator lights, reversing lights, turn signals, and braking lights. The harvesting device may in some embodiments be configured to collect the energy from the wires connected to all of the light devices of the vehicle or only one or more or some of them. By way of example, a vehicle has two (right and left) turn signals, and, thus, energy may be collected from both of them or only the one of them. In particular, the energy harvesting device may be configured to collect energy from 2, 3, 4, 5, or 6 or more of the light devices. By way of example, one light device is e.g. one of the turning signals either the turn signal to the right or the turn signal to the left.

It is further contemplated by the present invention that the energy harvesting device may further be connected to wires different from a light device. Such wires may e.g. be the ABS (Anti-lock Braking System), ESP (Electronic Stability Program) or TCS (Traction Control System) supply.

The term “light device of the vehicle” and “lights of the vehicle” is used interchangeably herein.

The vehicle may be a towed vehicle, i.e. vehicle towed by a towing vehicle. An example of such towed vehicle is a trailer, a caravan, or agricultural machines. A towed vehicle may in particular not be provided with driving lights. Accordingly, current is only running in the cables when the truck driving the trailer is braking or turning.

Thus, in a certain aspect, the invention relates to a tracking device for a towed vehicle comprising a light device for providing light, wherein the tracking device comprises:
an energy storage;
a positioning unit configured to determine the position of the tracking device and
a communication module configured to transmit wireless signals to an external receiver,
   wherein the tracking device comprises an energy harvesting device configured to charge the energy storage by the electrical power available in the electrical wires connected to the light device of the towed vehicle, said light device being selected among the indicator lights, the reversing lights, the braking lights, the turn signals, and combinations thereof, and wherein the energy harvesting device is a charge pump.

In a particular embodiment, the vehicle or the towed vehicle is a trailer.

The tracking device comprises an energy storage and a positioning unit configured to determine the position of the tracking device. The positioning unit may be of any suitable type and size.

The tracking device comprises a communication module configured to transmit wireless signals to an external receiver. The communication module may be of any suitable type and size.

The tracking device comprises an energy harvesting device configured to charge the energy storage by the electrical power available in the electrical wires connected to the light device of the vehicle. Accordingly, the harvesting device can harvest when current is running in the cables, e.g. when the truck driving the trailer is braking or turning.

It may be an advantage that the tracking device comprises an energy harvesting device configured to fully charge the energy storage by the electrical power available in the electrical wires connected to the light device.

Accordingly, if the light device is the turning lights or braking lights, the turning or braking action of the pulling or towing vehicle is sufficient to charge the tracking device. The terms “pulling” and “towing” are used interchangeably herein.

It may be beneficial that the harvesting device is configured to charge the energy storage sufficiently to allow the communication module to send at least one wireless signal to an external receiver by using the electrical power harvested from a single activity action of the vehicle or a pulling or towed vehicle.

In a certain embodiment of the tracking device, the harvesting device is configured to charge the energy storage sufficiently to allow the communication module to send a first and a second wireless signal to an external receiver by using the electrical power harvested from a single activity action of the towed vehicle. In another embodiments, the harvesting device is configured to charge the energy storage sufficiently to allow the communication module to send additional third and fourth wireless signals to an external receiver by using the electrical power harvested from a single activity action of the vehicle or towed vehicle. In principle, there is no limitation of the number of wireless signals, but the number will depend on the available harvested and stored energy.

By the term “single activity action” is meant that the light device is “on”, i.e. current running in the wires of the light device for a shorter or longer period of time. The single activity action may suitably have a duration of less than 30 seconds, preferably less than 20 seconds, such as 1-15 seconds.

In some cases, e.g. when the vehicle is parked, the vehicle may send a short pulse of current through one or more of the vehicle's light devices in order to determine whether a towed vehicle is connected to the vehicle. Such pulses may e.g. be sent each 20 minute for several hours following turning off the engine of the vehicle or the towing vehicle.

Thus, in some embodiments, the tracking device may further comprise a filtering unit. Such filtering unit is generally known in the art, and may be a standard or customisable filtering unit. Examples include, but are not limited to, SW (software) filters.

The filtering unit makes it possible to determine the quality of the pulse of current sent by the vehicle and, thus, activate the tracking device only if the pulse is derived from a single activity action. If this is not the case, the tracking device is switched off, thus, saving energy and lessen consumption of energy stored. E.g. the filtering unit may be configured to evaluate pulses having duration of 10-100 ms. In such cases, the filtering unit may keep the tracking device switched off, since a pulse of 10-100 ms is deemed a “testing pulse”.

In accordance herewith and in another aspect, the tracking device of the invention comprises
an energy storage;
a positioning unit configured to determine the position of the tracking device,
a communication module configured to transmit wireless signals to an external receiver, and
a filtering unit,
   wherein the tracking device comprises an energy harvesting device configured to charge the energy storage by the electrical power available in the electrical wires connected to the light device of the vehicle, said light device being selected among the indicator lights, the reversing lights, the braking lights, the turn signals, and combinations thereof, and wherein the energy harvesting device is a charge pump.

In yet another aspect, the tracking device of the invention comprises
an energy storage;
a positioning unit configured to determine the position of the tracking device,
a communication module configured to transmit wireless signals to an external receiver, and
a filtering unit,
   wherein the tracking device comprises an energy harvesting device configured to charge the energy storage by the electrical power available in the electrical wires connected to the light device of the towed vehicle, said light device being selected among the indicator lights, the reversing lights, the braking lights, the turn signals, and combinations thereof, and wherein the energy harvesting device is a charge pump.

The energy harvesting device is suitably a charge pump.

Hereby, it is possible to provide a simple, cheap and highly efficient tracking device that does not require a battery for securing that sufficient electrical power is available for the tracking device.

The energy harvesting device, such as the charge pump, may be provided with any suitable kind of capacitors as energy storage elements in order to create a “step-down” function; i.e. voltage (V) is lowered while the current (ampere, A) is increased. E.g. the voltage may be 12V, 24V or 48V. Usually, a voltage of 12V at 1,5 A is used, and thus the voltage is transformed to 3V at 12 A. The energy harvesting device such as the charge pump may use any suitable form of switching device to control the connection of voltages to the capacitor(s).

In some cases, the use of a charge pump is an appealing way of avoiding that the use of a battery is required.

In one embodiment, the tracking device according to the invention comprises an energy harvesting device having a charge pump comprising an electronic transformer configured to lower the voltage before storing the electrical energy. Hereby, the leakage current and thus the energy loss in the energy storage can be minimised.

In one embodiment, the tracking device according to the invention comprises an energy harvesting device having a charge pump comprising an electronic transformer configured to initially lower the voltage before storing the electrical energy, wherein the charge pump furthermore comprises an electronic transformer configured to increase the voltage after the electrical energy has been stored in the energy storage of the tracking device.

It may advantageous that the energy harvesting device comprises one or more capacitors.

It may be an advantage that the capacitors are “supercapacitors” used in a charge pump.

The supercapacitors preferably comprise electrostatic double-layer capacitance or electrochemical pseudocapacitance or combinations thereof.

The supercapacitors may be electrostatic double-layer capacitors applying carbon electrodes or derivatives. Hereby, a very high capacitance can be received.

The supercapacitors may be electrochemical pseudocapacitors applying metal oxide or conducting polymer electrodes with a high amount of electrochemical pseudocapacitance (electrochemical storage of electricity in an electrochemical capacitor).

Since supercapacitors are confined to 2.5-3.0V, higher voltages may be applied, however, they reduce the service life of the supercapacitors. Accordingly, it may be an advantage that the energy harvesting device comprises a transformer configured to lower the voltage before storing electrical energy in the supercapacitors.

To get higher voltages, several supercapacitors ay be connected in series. Since serial connection reduces the total capacitance and increases the internal resistance, it may be beneficial to limit the number of capacitors to e.g. one, two, three, four, five, six, seven or eight.

It may be beneficial that that energy harvesting device is configured to delay the energy harvesting so that no electrical energy is charged during a predefined time period.

Hereby, the load of the system can be reduced. The light devices (lamps) have a characteristic that is drawing high current in cold condition. Accordingly, a delay added before the power charger is started up decreases the load.

The delay of the energy harvesting may suitably be 10-100 ms. By way of example, the delay may be 10 ms, 30 ms, 50 ms or 75 ms or 100 ms.

Hereby, the electrical system of the vehicle or towed vehicle is prevented from being overloaded during the charging process.

It may be an advantage that the tracking device comprises a power management unit configured to switch on/off one or more modules of the tracking device. Hereby, the energy consumption can be reduced or even minimised.

It may be beneficial that the tracking device comprises a power management unit configured to switch on/off one or more modules of the tracking device independent of the activity of the processor (if the processor is running or powered down).

It may be advantageous that the tracking device comprises a communication module configured to transmit data via a telephone data network.

Hereby, the tracking device is capable of applying the telephone data network that is present in most areas in the world.

The telephone data network includes the standard Long-Term Evolution, LTE, also known as “4G LTE” for wireless communication of high-speed data for mobile phones and data terminals. The LTE includes applies the GSM/EDGE and UMTS/HSPA and CDMA2000 network technologies. Also, satellite communication is envisaged.

The communication module may be a radio frequency (RF) transmitting unit.

It may be an advantage that the tracking device comprises a movement sensor configured to detect acceleration or vibration of the tracking device.

Hereby, the tracking device is capable of detecting if the tracking device is moving indicating that the vehicle is also moving. This information can be applied to activate and/or deactivate the tracking device. In particular, the movement sensor may be used in combination with the filtering unit in order to further determine the quality of the pulses of current and to activate and/or deactivate the tracking device.

It may be an advantage that the tracking device is configured to be brought into a hibernation mode when no vibration or acceleration is detected by the movement sensor and/or the filtering unit during a predefined time period.

It may be an advantage that the tracking device is adapted to be brought into a hibernation mode when no vibration or acceleration is detected by the movement sensor during a predefined time period of e.g. 2 minutes, 5 minutes or 10 minutes. Furthermore, the tracking device may be adapted to be brought into a hibernation mode when a pulse of current detected by the filtering unit does not have the correct profile. The correct profile may e.g. be a pulse having a duration of 10-100 ms as described previously herein.

In a special embodiment, the connection to the data network may be continued (not logged off), if a light device is turned on for more than 1 minute (e.g. a backlight or parking light). Thereby, the costs for transmission of data packages can often be reduced. Furthermore, it may be possible to receive e.g. software updates or send information through the data network with a shorter interval.

It may be advantageous that the movement sensor comprises an accelerometer of any suitable type. The accelerometer may comprise piezoelectric, piezoresistive or capacitive components (e.g. applying a silicon micro-machined sensing element) configured to convert mechanical motion into an electrical signal. The accelerometer may comprise a microchip-packaged micro electro-mechanical system.

It may be beneficial that the movement sensor comprises a gyroscope e.g. a microchip-packaged gyroscope.

In one embodiment, according to the invention, the movement sensor comprises a vibration sensor. The vibration sensor may be a vibration sensor of any suitable type. However, it may be an advantage that the vibration sensor is a low power sensor in order to minimise the power consumption.

It may be an advantage that the tracking device comprises a processor and a wake up device electrically connected to the processor and configured to activate the processor as response to a received input voltage from a light device or another signal of the vehicle or a movement sensor of the vehicle.

Hereby, the wake-up device can be used to control the activity of the processor in order to reduce the energy consumption of the tracking device. Accordingly, a less energy demanding tracking device can be provided.

In one embodiment of the invention the wake-up device is an integrated part of the processor.

In a preferred embodiment of the invention the tracking device is configured not to transmit wireless signals, when no movement or vibration has been detected by the movement sensor for a predefined time period, or when the filtering unit has excluded pulses of current.

Hereby, energy can be saved when the vehicle does not move for a predefined time period of e.g. 5 minutes, 15 minutes, 30 minutes, 1 hour, 2 hours, 3 hours, 4 hours, 5 hours, 6 hours or more.

It may be beneficial that the power management unit is configured to control the delivery of power to the positioning unit in such a manner that the power management unit only delivers power to the positioning unit until the positioning unit has determined the position of the tracking device.

Hereby, the power management unit can minimise the energy consumption of the positioning unit and thus the tracking device. Consequently, the energy consumption of the tracking device can be decreased.

In a preferred embodiment of the invention the power management unit is configured to turn off the processor when the positioning unit is turned on. The tracking device preferably is adapted to “wake-up” the processor, if the position has not been detected by the positioning device within a predefined time period of e.g. 1 minute, 2 minutes, 3 minutes of 5 minutes.

It may be an advantage that the communication module is activated in order to send information when the positioning unit is switched off.

Hereby, the activity of the communication module can be minimised with the purpose of reducing the energy expenditure of the tracking device.

It may be an advantage that the tracking device is configured to send a first data package at a first time, a second data package at a second time, a third data package at a third time and a fourth data package at a fourth time, wherein the data packages are sent by increasing delay.

It may be an advantage that the time delay between the two first data packages has a predefined duration and that the time delay between the second and third data packages is larger than the first predefined duration.

In an embodiment, the tracking device is configured to send a first data package at a first time, a second data package at a second time, a third data package at a third time and a fourth data package at a fourth time, wherein the delay between the second and third data packages is twice as large as the delay between the first and the second data packages.

In a certain embodiment, the tracking device is configured to send a first data package at a first time, a second data package at a second time, a third data package at a third time and a fourth data package at a fourth time, wherein the delay between the third and fourth data packages is twice as large as the delay between the second and the third data packages.

In another embodiment of the invention, the tracking device is configured to send more than four data packages.

In yet another embodiment of the invention, the tracking device is configured to determine the duration of the time period between two successive data packages on the basis of one or more energy storage measurements.

In a particular embodiment of the invention, the tracking device is configured to determine the duration of the time period between two successive data packages on the basis the voltage of a capacitor of the energy storage.

Accordingly, if the energy storage is fully loaded, the voltage of a capacitor of the energy storage will be high. Therefore, the duration of the time period between two successive data packages may be short.

On the other hand, if the amount of energy stored in the energy storage is low, the voltage of a capacitor of the energy storage will be low. Therefore, the duration of the time period between two successive data packages will be longer in order to limit or minimise the energy consumption.

It may be an advantage that the tracking device is configured to keep sending data packages when the tracking device is energy supplied on a continuous basis (e.g. when coupled to driving lights of the vehicle, permanent lights of the vehicle or towed vehicle, or when coupled to several light devices of the vehicle or towed vehicle). The light devices are those mentioned in the foregoing, and it is to be understood that the coupling may be to more than one of the light devices, to some of the light devices or to all the light devices. In particular, it is contemplated that the coupling may suitably be to 2-6 light devices. In particular, coupling of the energy harvesting device to several light devices may result in a reduced need to transmit data packages since the since the communication module can stay “logged on” for a prolonged period of time, and this will in turn reduce the costs of the communication.

It may be an advantageous that the tracking device is configured to detect the power source and that the tracking device is configured to transmit a signal comprising information about the power source.

Hereby, the information may be used to track the vehicle and its activity. The power source may be any of the light devices of the vehicle such as the indicator lights, the braking lights, the turning signals, or the driving lights of the vehicle.

In an embodiment, the tracking device comprises a processor adapted to generate an information package comprising information about the energy source so that the end user knows if the tracking device was charged by energy from any of the light devices, suitably the driving or running lights, the braking lights or the indicator lights (including hazard warning light).

It may be beneficial that the position of the tracking device is sent via the Internet to reach the end user. Hereby, the end user may receive notifications by using a smart phone or a computer.

It may be beneficial that the tracking device is covered with a protective material such as silicone or epoxy.

It may be an advantage that the tracking device comprises a printed circuit board that is covered with a solid or gelatinous compound for providing resistance to shock and vibration and for exclusion of moisture and corrosive agents.

The protective material may be a thermo-setting plastic or a silicone rubber gel. It is possible to coat the tracking device with a layer of transparent conformal coating rather than potting.

It may be advantageous that the charge velocity of the energy harvesting device depends on the vehicle electrical system voltage.

In a preferred embodiment of the invention the tracking device is configured to automatically detect the input voltage, wherein the tracking device is configured to adapt the charge velocity of the energy harvesting device to the automatically detected input voltage.

In a preferred embodiment of the invention, the tracking device is configured to receive wireless signals from an external device.

The tracking device may comprise a dedicated antenna for receiving wireless signals e.g. from a satellite or another external device.

It may be beneficial that the tracking device comprises a time device provided with a separate energy storage.

Hereby, the time on which the position of the tracking device and thus the vehicle is determined can be established.

In a preferred embodiment of the tracking device, the tracking device is configured to synchronize the time device with a time signal received from an external device communicating with the tracking device.

The object of the invention may be achieved by a vehicle having a tracking device as described herein.

### DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1 A shows a schematic perspective top view of a tracking device according to one embodiment of the invention;

FIG. 1 B shows a schematic perspective end view of a tracking device according to one embodiment of the invention in which the tracking device is covered with a protective material such as silicone or epoxy;

FIG. 2 shows a schematic view of a diagram illustrating the elements of a tracking device according to an embodiment of the invention;

FIG. 3 schematically illustrates how a tracking device according to an embodiment of the invention communicates with an end user;

FIG. 4 shows a schematic illustration of a trailer with an integrated tracking device according to an embodiment of the invention;

FIG. 5 A shows a graph illustrating how the data packages are sent by a tracking device according to one embodiment of the invention;

FIG. 5 B shows a graph illustrating the charging profile of a tracking device according to one embodiment of the invention;

FIG. 6 A shows a graph illustrating how the data packages are sent by a tracking device connected to running light of a vehicle and

FIG. 6 B shows a graph illustrating how the data packages are sent by a tracking device during a turning action.

### DETAILED DESCRIPTION OF THE INVENTION

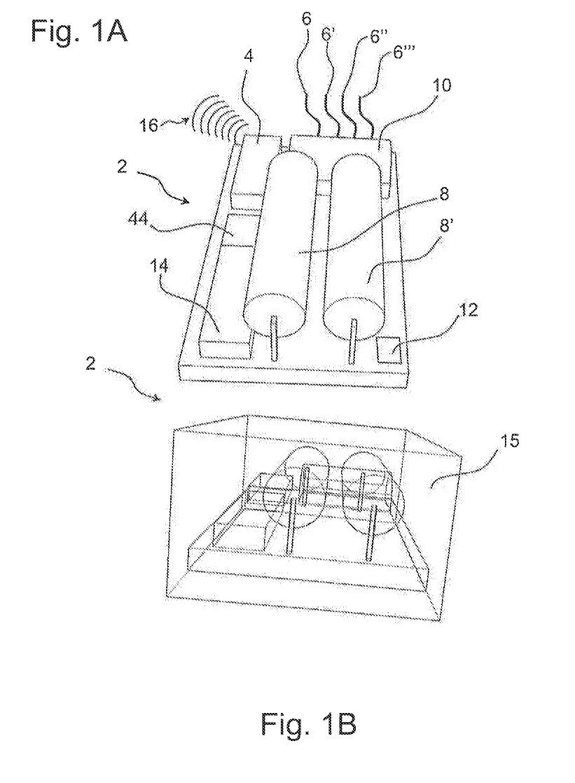

Referring now in detail to the drawings for the purpose of illustrating preferred embodiments of the present invention, a tracking device according to one embodiment of the present invention is illustrated in FIG. 1 A.

FIG. 1 A illustrates a schematic perspective top view of a tracking device 2 according to one embodiment of the invention. The tracking device 2 comprises a printed circuit board equipped with an antenna 4 configured to transmit a wireless signal 16, a movement sensor 12, a first capacitor 8, a second capacitor 8′ and a processor 14 connected to a communication module 10 electrically connected to four electrical connections 6, 6′, 6″, 6′″ for external connection to the wires of a vehicle such as wiring for running lights, brake lights and indicators.

The capacitors 8, 8′ constitute an energy storage providing enough electrical energy for sending a predefined number of information packages as wireless signals 16 by means of the antenna 4.

The information may be used to track the vehicle and its activity. In a preferred embodiment according to the invention, the tracking device 2 comprises a processor 14 adapted to generate an information package comprising information about the energy source so that the end user knows if the tracking device 2 was charged by energy from running lights, brake lights or indicators.

The tracking device 2 comprises a positioning device 44 configured to determine the position of the tracking device 2. The positioning device 44 may be a global satellite-based navigation system such as a GPS receiver, a GLONASS navigation device or a Galileo navigation device.

FIG. 1 B illustrates a schematic perspective end view of a tracking device 2 according to one embodiment of the invention in which the tracking device 2 is covered with a protective material 15 such as silicone or epoxy.

The tracking device 2 corresponds to the one illustrated in FIG. 1 A, however, the complete printed circuit board has been covered with a solid or gelatinous compound for providing resistance to shock and vibration and for exclusion of moisture and corrosive agents.

The protective material 15 may be a thermo-setting plastic or a silicone rubber gel. It is possible to coat the tracking device with a layer of transparent conformal coating rather than potting.

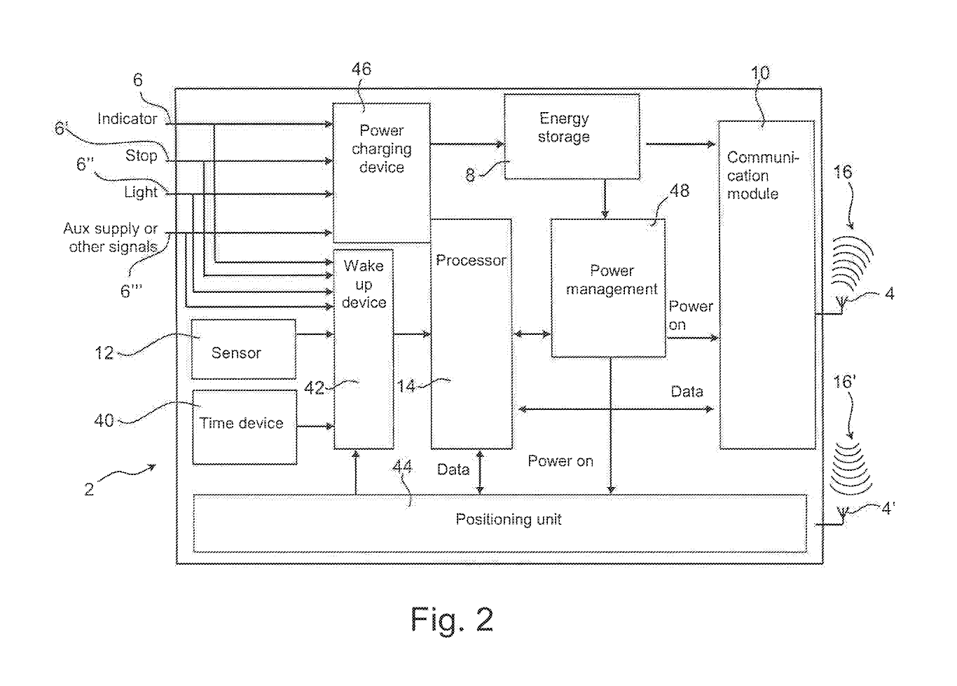

FIG. 2 illustrates a schematic view of a diagram illustrating the elements of a tracking device 2 according to an embodiment of the invention.

The tracking device 2 comprises a first electrical connection 6 adapted to be electrically connected to the indicators of a vehicle (e.g. a truck trailer), a second electrical connection 6′ adapted to be electrically connected to the stop light of the vehicle, a third electrical connection 6″ adapted to be electrically connected to the running light of the vehicle and a fourth electrical connection 6′″ adapted to be electrically connected to either aux supply or other signals. Accordingly, the tracking device 2 is capable of charging electrical power from indicators, stop lights, running light, hazard warning light, aux supply or other signals by means of the electrical connections 6, 6′, 6″, 6′″. The tracking device 2 is capable of detecting if the left, right or both indicators are activated. The “aux supply or other signals” may include any light device (e.g. ceiling light or door light).

The tracking device 2 comprises a power charging device or energy harvesting device 46 electrically connected to the electrical connections 6, 6′, 6″, 6′″. Accordingly, the power charging device 46 is capable of harvesting electrical power through the electrical connections 6, 6′, 6″, 6′″ when current is running through these.

The power charging device 46 is electrically connected to an energy storage 8 that may comprise one or more capacitors as illustrated in FIG. 1 A. Accordingly, the electrical energy harvested by the power charging device 46 can be stored in the energy storage 8. The energy storage 8 is furthermore electrically connected to communication module 10 formed as a radio frequency module that is capable of sending wireless signals 16 by means of an antenna 4. The communication module 10 may be adapted to transmit data via a telephone data network.

The power charging device 46 is configured to delay the energy harvesting so that no electrical energy is charged in a predefined time period e.g. 10 ms, 30 ms, 50 ms or 75 ms or 100 ms in order not to overload the electrical system.

The electrical connections 6, 6′, 6″, 6′″ are electrically connected to a wake up device 42 that is configured to bring the tracking device 2 from a hibernation mode to an active mode in which the processor 14 of the tracking device 2 is activated. The processor 14 is controlled by means of an executable program.

The tracking device 2 comprises a movement sensor 12 electrically connected to the wake-up device 42. The movement sensor 12 is capable of detection of motion (acceleration and/or vibrations of the tracking device 2). The tracking device 2 may preferably be configured to be brought into a hibernation mode when no vibration or acceleration is detected by the movement sensor 12 during a predefined time period.

The wake-up device 42 is configured to “wake up” the processor 14 when an input voltage is received from an indicator, stop light, driving light or another signal of the vehicle in which the tracking device 2 is installed. The wake-up device 42 is configured to “wake up” the processor 14 when an input voltage is received from the movement sensor 12.

The tracking device 2 comprises a time device 40 configured to determine the time. The time device 40 may comprise an internal energy storage for providing the energy required to ensure that the time device 40 is active. In a preferred embodiment, the time device 40 is configured to be synchronised by a server in order to correct the time of the time device 40.

The tracking device 2 comprises a positioning device 44 configured to determine the position of the tracking device 2. The positioning device 44 may be satellite-based navigation system such as a GPS receiver, a GLONASS navigation device, a BeiDou navigation device or a Galileo navigation device or a combination of two or more of these devices. The positioning device 44 comprises an antenna 4′ and is electrically connected to the wake-up device 42 and is configured to determine the position of the tracking device 2 (and the vehicle in which the tracking device 2 is installed) as soon as the wake-up device 42 is “activated”. As soon as the position of the tracking device 2 is determined by the positioning device 44, the positioning device 44 is deactivated in order to reduce the power consumption of the tracking device 2. The activation and deactivation of the positioning device 44 may controlled by the processor 14 that is electrically connected to the positioning device 44 and to the wake-up device 42. The positioning device 44 is equipped with an antenna 4′ enabling that the positioning device 44 can receive wireless signals 16′ from the required satellites.

The tracking device 2 comprises a positioning device 44 that may be configured to determine the position of the tracking device 2 by means of GSM (Global System for Mobile Communications) stations, Wi-Fi networks or radio frequency (RF) networks of any suitable type.

The tracking device 2 comprises a power management unit 48 electrically connected to the energy storage 8, the processor 14, the positioning unit 44 and the communication module 10.

The power management unit 48 is configured to manage the power consumption in or to make the harvested energy last as long as possible. The power management unit 48 is configured to only energize the positioning unit 44 until it has determined the position of the tracking device 2.

The processor 14 is capable of generating and transmitting data to the communication module 10 for the purpose of sending the data as a wireless radio frequency signal 16. The data may comprise information about the position of the tracking device 2 at the time determined by the time device 40 as well as information about the energy source that the tracking device 2 was charged from (the running lights, brake lights or indicators of the vehicle).

The processor 14 is configured to generate and send data to the communication module 10 that is configured to transmit radio frequency signals 16 by means of the antenna 4. The power management unit 48 is configured to control the power delivery to the positioning unit 44. Accordingly, the power management unit 48 may be set to only deliver power to the positioning unit 44 in the initial phase of which the tracking device 2 is active. In this way, it is possible to save energy by deactivating (restrict the power delivered to) the positioning unit 44 when the positioning unit 44 has determined the position of the tracking device 2.

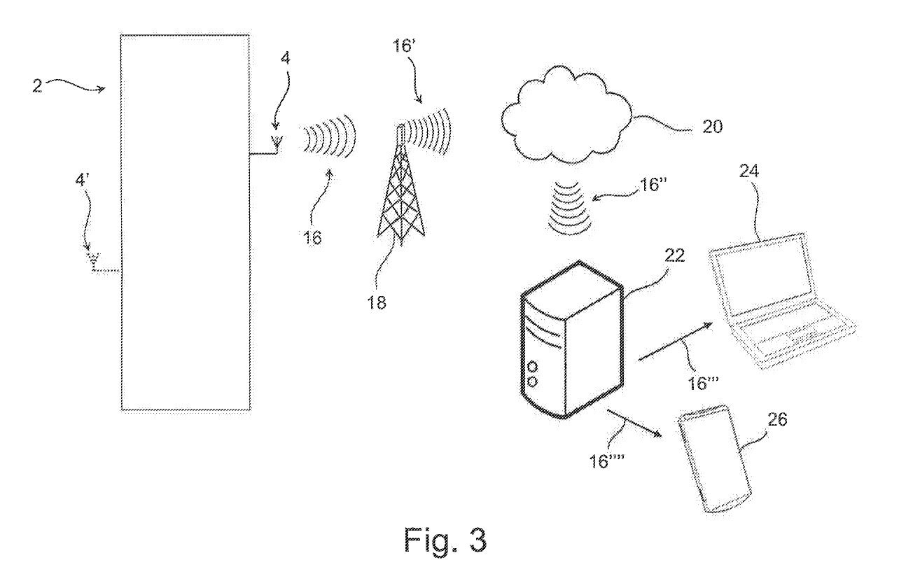

FIG. 3 shows a schematic illustration of how a tracking device 2 according to an embodiment of the invention communicates with an end user having a mobile phone 26 or a computer 24. The tracking device 2 comprises a first antenna 4′ for receiving wireless signals (e.g. from satellites). The tracking device 2 may comprise a positioning device being a global satellite-based navigation system such as a GPS receiver, a GLONASS navigation device, a Galileo navigation device, a BeiDou navigation device or a combination of two or more of these devices.

The tracking device 2 comprises a second antenna 4 for transmitting wireless signals 16 being received by a base station 18 that forwards the signals as wireless signals 16′ via the Internet 20. Signals 16″ are sent via the Internet 20 to a server 22 that forwards signals 16′″, 16″″ (e.g. in a modified form) to the computer 24 or smart phone 26 of the end user. Hereby, the end user will be notified with information indicative or determinative of the position and/or the activity of the vehicle in which the tracking device 2 is installed. The end user may be provided with the position and activity (e.g. braking light activity) of the vehicle at the time at which the tracking device 2 determined the position and the activity.

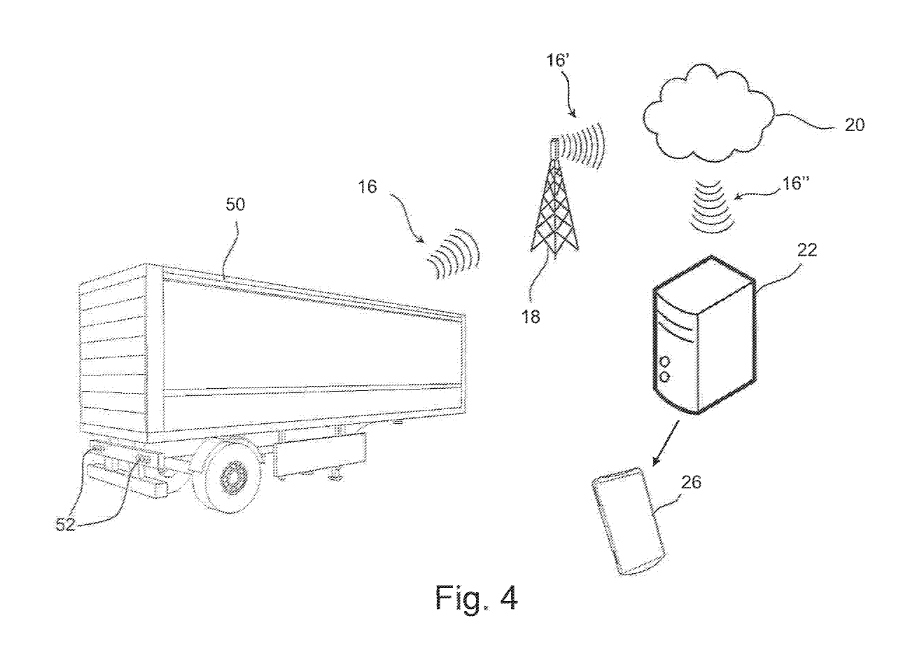

FIG. 4 illustrates a schematic illustration of a trailer 50 with an integrated tracking device according to an embodiment of the invention. The trailer 50 is equipped with a tracking device according to the invention that is capable of transmitting a wireless signal 16. The trailer 50 is adapted to be attached to a truck (not shown). The trailer 50 is provided with light devices 52 including indicators, stop light and optionally running light.

The tracking device is electrically connected to electrical connections electrically connected to: a) the indicators of the trailer 50; b) the stop light of the trailer 50; c) the running light of the trailer 50 and d) aux supply or other signals of the trailer 50.

The signals 16 sent from the tracking device of the trailer 50 are received by a local base station 18 that forwards the signals as signals 16′ via the Internet 20 as signals 16″ to a server 22. The server 22 sends signals 20 the mobile phone 26 of the end user.

Accordingly, the end user can be provided with the position and activity of the trailer 50 at the time at which the tracking device determined the position and the activity of the trailer 50.

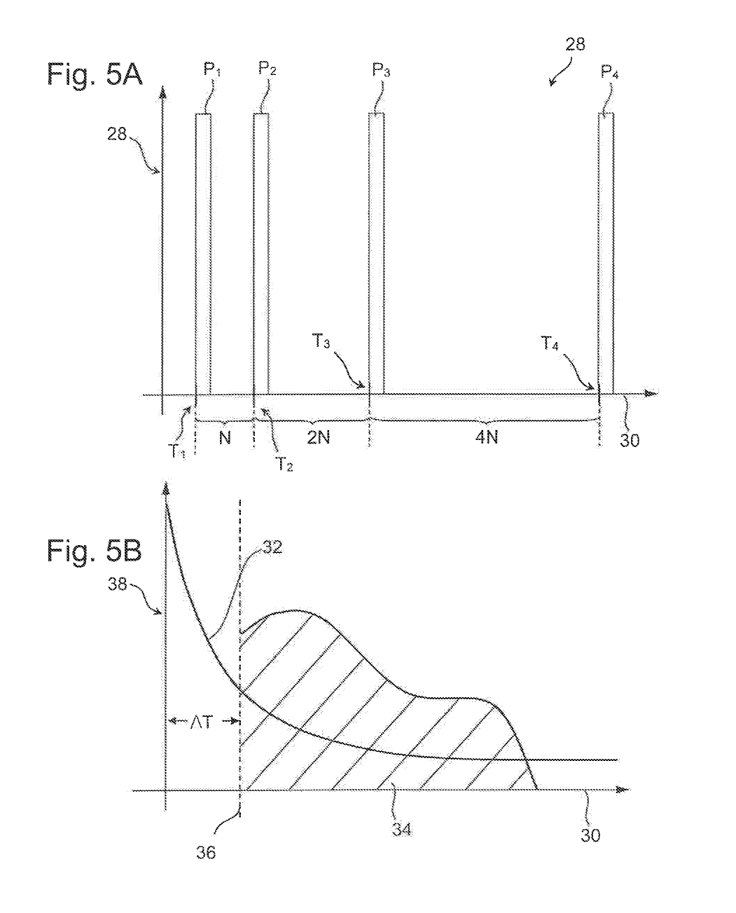

FIG. 5 A shows a graph illustrating how data packages P₁, P₂, P₃, P₄ are sent by a tracking device according to one embodiment of the invention. The graph illustrates the data package activity 28 as function of time 30. It can be seen that a first data package P₁ is sent at a first time T₁, that a second data package P₂ is sent at a second time T₂, that a third data package P₃ is sent at a third time T₃ and that a fourth data package P₄ is sent at a fourth time T₄. Furthermore, it can be seen from FIG. 5 A that the data packages P₁, P₂, P₃, P₄ are sent by increasing delay. The time delay between the two first data packages P₁, P₂ is N. The time delay between the second and third data packages P₂, P₃ is 2N, whereas the time delay between the third and fourth data packages P₃, P₄ is 4N. This means that the duration of subsequent time delays is subsequently doubled.

It is possible to have a tracking device that is configured to transmit more data packages P₁, P₂, P₃, P₄. In one embodiment of the tracking device according to the invention, the tracking device may be adapted to transmit five, six, seven or eight data packages P₅, P₆, P₇, P₈.

In a preferred embodiment, the tracking device is configured to determine the duration of the time period between two successive data packages P₁, P₂, P₃, P₄, P₅, P₆, P₇, P₈ on the basis of one or more energy storage measurements such as the voltage of a capacitor of the energy storage.

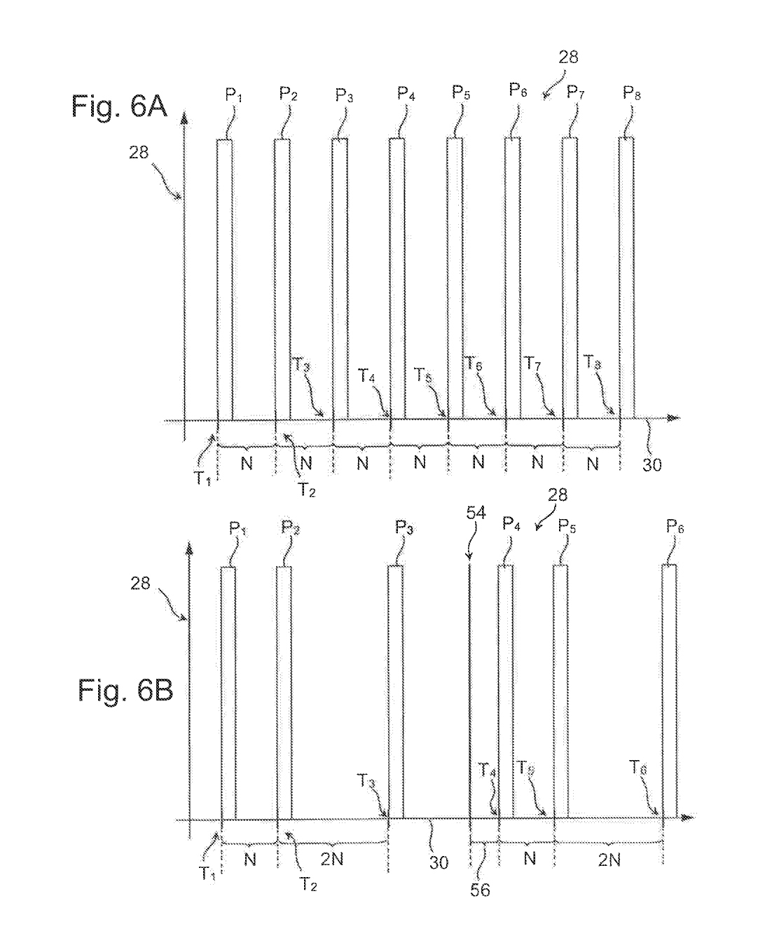

Accordingly, if the energy storage is fully stored, as indicated in FIG. 6, the voltage of a capacitor of the energy storage will be high. Therefore, the duration of the time period between the successive data packages are constant and relative short.

On the other hand, if the amount of energy stored in the energy storage is low, the voltage of a capacitor of the energy storage will be low. Therefore, the duration of the time period between two successive data packages P₁, P₂, P₃, P₄, P₅, P₆, P₇, P₈ will be longer in order to limit the energy consumption.

FIG. 5 B shows a graph illustrating the charging profile of a tracking device according to one embodiment of the invention. The graph illustrates the current curve 32 depicting the current 38 as function of time 30 for a typical incandescent light bulb. It can be seen that in the first time period ΔT representing a predefined delay time, no charge 34 is harvested. The current 34 harvested is indicated by a hatched area below the current curve 32. At time 36, the tracking device starts harvesting electrical energy by means of a power charging device as described with reference to FIG. 2. The power charging device is electrically connected to an energy storage capable of storing the electrical energy harvested by the power charging device.

The power charging device is configured to delay the energy harvesting so that no electrical energy is charged in the predefined time period time period ΔT that may be e.g. 10 ms, 30 ms, 50 ms or 75 ms or 100 ms.

Hereby, the load of the electrical system supplying electrical power to the energy harvesting device can be reduced.

FIG. 6 A) shows a graph illustrating how eight data packages P₁, P₂, P₃, P₄, P₅, P₆, P₇, P₈ are sent by a tracking device according to one embodiment of the invention. The graph illustrates the data package activity 28 as function of time 30. It can be seen that a first data package P₁ is sent at a first time T₁, that a second data package P₂ is sent at a second time T₂, that a third data package P₃ is sent at a third time T₃, that a fourth data package P₄ is sent at a fourth time T₄, that a fifth data package P₅ is sent at a fifth time T₅, that a sixth data package P₆ is sent at a sixth time T₆, that a seventh data package P₇ is sent at a seventh time T₇ and that an eighth data package P₈ is sent at an eighth time T₈. The data packages P₁, P₂, P₃, P₄, P₅, P₆, P₇, P₈ are sent on a regular basis with a fixed time period N between successive packages.

The situation displayed in FIG. 6 A) corresponds to a tracking device according to the invention connected to the running light of a vehicle. Accordingly, when the tracking device according to the invention is connected to the running light of a vehicle there is constantly access to electric power. Therefore, the energy storage is kept full and the data packages P₁, P₂, P₃, P₄, P₅, P₆, P₇, P₈ are sent on a regular basis.

FIG. 6 B) shows a graph illustrating how six data packages P₁, P₂, P₃, P₄, P₅, P₆ are sent by a tracking device according to one embodiment of the invention. The graph illustrates the data package activity 28 as function of time 30. It can be seen that a first data package P₁ is sent at a first time T₁, that a second data package P₂ is sent at a second time T₂, that a third data package P₃ is sent at a third time T₃, that a fourth data package P₄ is sent at a fourth time T₄, that a fifth data package P₅ is sent at a fifth time T₅ and that a sixth data package P₆ is sent at a sixth time T₆.

The duration of the time period 2N between the sending of the second data package P₂ and the third data package P₃ is twice as long as the duration of the time period N between the sending of the first data package P₁ and the second data package P₂.

Since the energy level of the energy storages gradually decreases when the data packages P₁, P₂, P₃ are sent by increasing delay. However, since a turning action 54, indicated by a solid line, is detected by the tracking device a new series of the data packages P₄, P₅, P₆ are sent by the tracking device. The time period 56 between the detection of the turning action 54 and the sending of the fourth data package P₄ at the time T₄ is indicated.

The duration of the time period 2N between the sending of the fifth data package P₅ and the sixth data package P₆ is twice as long as the duration of the time period N between the sending of the fourth data package P₄ and the fifth data package P₅.

### LIST OF REFERENCE NUMERALS

2 Tracking device

4, 4′ Antenna

6, 6′ Electrical connection

8, 8′ Energy storage

10 Communication module

12 Movement sensor

13 Filtering unit

14 Processor

15 Protective material

16, 16′, 16″, 16′″, 16″″ Signal

18 Base station

20 Internet

22 Server

24 Computer

26 Mobile phone

28 Activity

30 Time

32 Current curve

34 Charge

36 Time

38 Current

40 Time device

42 Wake-up device

44 Positioning unit

46 Power charging device/Energy harvesting device

48 Power management unit

50 Trailer

52 Light device

54 Turning action

56, N Time delay/time period

P₁, P₂, P₃, P₄, P₅, P₆, P₇, P₈ Data package

T₁, T₂, T₃, T₄, T₅, T₆, T₇, T₈ Time

DT Delay time

1. A tracking device for a vehicle, the vehicle including a light device for providing light, the tracking device comprising:
an energy storage;
a positioning unit configured to determine the position of the tracking device;
a communication module configured to transmit wireless signals to an external receiver; and
an energy harvesting device operatively connected to at least one electrical wire of the vehicle, wherein;
the at least one electrical wire is connected to the light device,
the energy harvesting device is configured to charge the energy storage by electrical power available in the at least one electrical wire and wherein the energy harvesting device is configured to detect an initial presence of the electrical power available in the at least one electrical wire and to delay the energy harvesting so that no electrical energy is charged in a predefined time period after detecting the initial presence of the electrical power, and
the energy harvesting device is a charge pump.

2. The tracking device of claim 1, wherein the energy harvesting device includes at least one capacitor.

3. (canceled)

4. The tracking device of claim 1, further comprising a power management unit configured to switch on/off at least one of the positioning unit, the communication module, and the energy harvesting device.

5. The tracking device of claim 1 wherein the communication module is configured to transmit data via a telephone data network.

6. The tracking device of claim 1 further comprising a movement sensor configured to detect at least one of acceleration and vibration of the tracking device.

7. The tracking device of claim 1 further comprising a filtering unit configured to detect pulses of current in the at least one electrical wire of the vehicle.

8. The tracking device of claim 1 further comprising:
a processor; and
a wake-up device configured to activate the processor in response to a received input voltage from at least one of: the at least one electrical wire connected to the light device; another signal of the vehicle, and a movement sensor of the vehicle.

9. The tracking device of claim 4, wherein the power management unit is configured to control the delivery of power to the positioning unit in such a manner that the power management unit only delivers power to the positioning unit until the positioning unit has determined the position of the tracking device.

10. The tracking device of claim 1, wherein the tracking device is configured to identify a specific wire selected from the at least one electrical wire and that the tracking device is configured to transmit a signal comprising information about the specific wire.

11. The tracking device of claim 1, wherein the charge velocity of the energy harvesting device depends on the vehicle electrical system voltage.

12. The tracking device of claim 1, further comprising a time device provided with a separate energy storage.

13. A vehicle comprising:
a light device for providing light; and
the tracking device of claim 1.
